(19) United States
(12) Patent Application Publication
(10) Pub. No.: US 2014/0058545 A1
(43) Pub. Date: Feb. 27, 2014

(54) SYSTEM AND METHOD FOR PROVIDING AN ALUMNI ENGAGEMENT PLATFORM AND GAME

(71) Applicants: Adam Jae Chun Lee, Honolulu, HI (US); Mikey Mikela Fujihara, Honolulu, HI (US)

(72) Inventors: Adam Jae Chun Lee, Honolulu, HI (US); Mikey Mikela Fujihara, Honolulu, HI (US)

(73) Assignee: NOJUICE.COM, INC., Honolulu, HI (US)

(21) Appl. No.: 13/593,466

(22) Filed: Aug. 23, 2012

(51) Int. Cl. A63F 13/12

(52) U.S. Cl. CPC A63F 13/12
USPC 700/91

(57) ABSTRACT

There is provided a system and method and method for playing a multi-player interactive game in conjunction with a specific college sports game or other specific event, and a platform for college sports, alumni, booster clubs and similar organizations to accept donations and earn revenue through advertisements. The system and method may be implemented in many forms, including via the internet or one or more computers networked together, or on a personal mobile device such as a tablet or smart phone.

### BACKGROUND

A number of companies offer Internet based ways to engage in a sporting event or events. The majority of these offer traditional betting, fantasy sports pick ‘em challenges over multiple games, or more recently betting exchanges.

In traditional betting the player is playing against the “house,” “bookie” or bookmaker of a gambling establishment. The house collects a “commission” known as the vigorish, “vig,” “cut,” “take” or simply the “juice.” The juice is usually 10-20% against traditional houses and 5% for betting exchanges. In fantasy sports, the player is managing it fantasy team of players over a variety of real teams. In betting exchanges, the player's bets are matched against each other with no house.

However, existing systems fail to provide computer implemented systems and methods for managing fantasy teams and supporting related organizations. Many fans love on team and want to support and have action on the game with their one specific team, and are not interested in spending the time to manage a fantasy team, nor do they want to gamble with a house or betting exchange because of a variety of reasons, whether moral or monetary.

If available many fans would find that it is far more fun and engaging to make a variety of predictions within one game for sponsored prizes and recognition. Such fans would enjoy this because they could have an ability to donate and support the team or related organization easily. However, other companies do not provide the users with the ability to do that.

While some companies offer systems for betting against the house, such systems do not allow for the above described experience because of the juice paid to the house on each bet.

The foregoing examples of the related art and limitations related therewith are intended to be illustrative and not exclusive. Other limitations of the related an will become apparent upon a reading of the specification and a study of the drawings.

### SUMMARY

The following examples and aspects thereof are described and illustrated in conjunction with systems, tools, and methods that are meant to be exemplary and illustrative, not limiting in scope. In various examples, one or more of the above-described problems have been reduced or eliminated, while other examples are directed to other improvements.

Herein, there is provided a system and method for playing a multi-player interactive game in conjunction with an event, for example, a specific college sports game. Further, there is provided a platform for individuals associated with the event, such as college sports, alumni, booster clubs and similar organizations to accept donations and earn revenue through advertisements. The game can be divided up into a plurality of sub-events related to the one event, with a plurality of possible outcomes for each sub-event within that one event.

According to a method described herein, prior to the event, lines for each sub-event can be assigned based on data describing the event, such as data provided by a third party data feed. The method can implement an algorithm to continuously update the line for individual sub-events using real time statistics. Players can attempt to predict yes or no, or over or under, for each sub-event before the game starts, taking into consideration the line for each sub-event. In addition, there can be tiebreakers of various types.

As the predictions for the sub-events are determined as a final, player scores can be calculated for each player by assigning one or more points, or fractions thereof for each of the player's predicted outcomes that match actual outcomes. Statistics related to the sub-events can be continuously updated during the event and displayed next to player's predictions. Final points earned for each player can be calculated, and winners and final standings determined. Winners may or may not receive a prize.

There can be a method implemented using the system described above such as through a computer executing software described herein, and configured to provide an Alumni Engagement Platform & Game. Such a method could implement the steps of receiving predictions from a plurality of users via a communications network including predictions for sub-events within one event.

The system and method can be implemented in many forms, including via the Internet or one or more computers networked together, or on a personal mobile device such as a tablet or smart phone. Such may or may not be provided free of charge without requirement of purchase.

### BRIEF DESCRIPTION OF THE DRAWINGS

FIG. 1A depicts a block diagram of an example of a system for playing a multi-player interactive game in conjunction with an event.

FIG. 1B depicts a block diagram of an example of a client for playing a multiplayer interactive game in conjunction with an event.

FIG. 1C depicts a block diagram of an example of a server for playing a multiplayer interactive game in conjunction with an event.

FIG. 2A visualizes an example of a login screen.

FIG. 2B depicts a flow diagram of an example of a routine that allows the user to login to the service with an OpenID account.

FIG. 3A is a flow diagram of an example of a routine to retrieve challenges for a team.

FIG. 4A illustrates a view of an example for a challenges' details.

FIG. 4B is a flow diagram of a routine to retrieve challenge details.

FIG. 5A illustrates an example of a making predictions for the sub-events for a challenge.

FIG. 5B is a flow diagram of an example of a routine to make picks for the sub-events for a challenge.

FIG. 5C is a flow diagram of an example of a routine useful to create sub-events.

FIG. 6A illustrates a view of an example of a user interface useful to give a user the option to share, donate, view sponsor advertisement, and details of the challenge.

FIG. 6B illustrates an example of a donation screen.

FIG. 6C illustrates an example of a share screen.

FIG. 6D illustrates an example of a share.

FIG. 7A illustrates an example of viewing a user's sub-event picks against the current live game state.

FIG. 7B is a flow diagram of an example of a routine useful to enable game updates to a client application.

FIG. 7C is a flow diagram of an example of a routine to push game updates to a client application.

FIG. 7D visualizes an example of receiving a challenge update notification.

FIG. 7E is a flow diagram of an example of a routine to update game and challenge states.

FIG. 8A visualizes an example of the final result view for a challenge as it pertains to a user's overall final place in the challenge.

FIG. 8B visualizes an example of a user's place amongst friends in a challenge.

FIG. 8C visualizes an example of a user's place amongst all users in a challenge.

FIG. 9 depicts an example of a system for playing a multi-player interactive game in conjunction with an event.

### DETAILED DESCRIPTION

In the following description, several specific details are presented to provide a thorough understanding. One skilled in the relevant art will recognize, however, that the concepts and techniques disclosed herein can be practiced without one or more of the specific details, or in combination with other components, etc. In other instances, well-known implementations or operations are not shown or described in detail to avoid obscuring aspects of various examples disclosed herein.

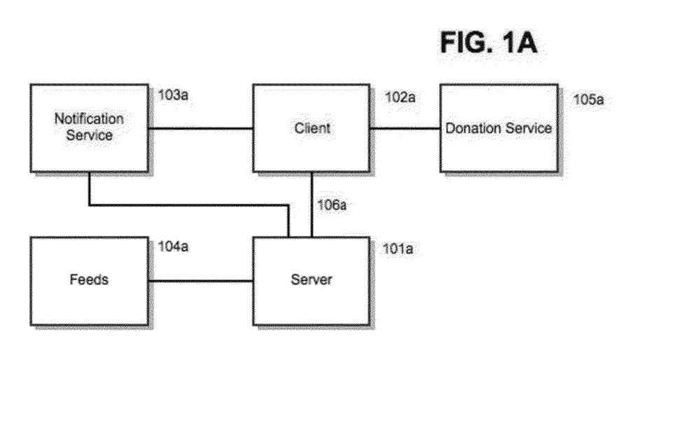

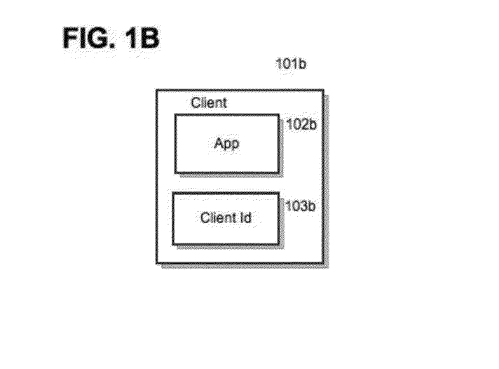

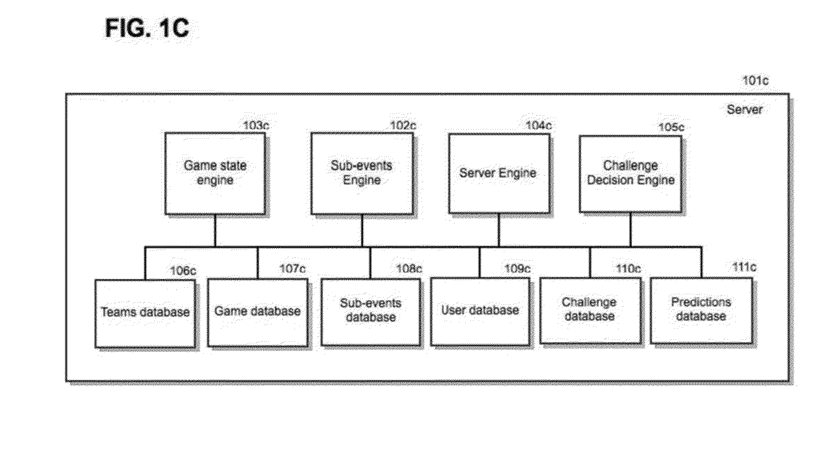

FIG. 1A depicts a block diagram of an example of a system for playing a multi-player interactive game in conjunction with an event. FIG. 1A includes the server 101a, client 102a, notification service 103a, feeds 104a, donation service 105a, and network 106a.

Server 101a can be a system including one or more computing devices for storing, hosting, and retrieving information as well as executing algorithms. The server 101a can run the algorithms necessary to run and maintain the multiple computing devices. The server 101a can provide encryption and communicate over a network, for example an Internet protocol (IP) based network. The server 101a can connect to third-party data services to retrieve as well as to write data ranging in complexity from a simple file to a complex combination of files, messages, structured data, and related information. The server 101a can provide an interface over the Internet to retrieve data and execute algorithms on the server or third-party services. The server 101a can store information on a storage medium such as memory, hard disk drive, or solid-state drive.

Client 102a can be a computation device that is able to connect to the server 101a over a network the Internet or other communication channel to play a multi-player interactive game. The client 102a can store information on a storage medium such as memory, hard disk drive, or solid-state drive. The client 102a can have a display to show information. The client 102a can have one or many input devices such as a touchscreen, keyboard, or mouse. The client 102a can run algorithms necessary to display information. The client 102a can connect to services over the Internet or other communication channel to execute algorithms and to retrieve as well as to write data ranging in complexity from a simple file to a complex combination of files, messages, structured data, and related information. The client 102a can receive push notifications through services. The client 102a can be any computing device, such as for example a computer, laptop, smart phone or other device able to provide network access for sending and receiving data. The client 102 is able to interface with an individual, particularly an individual interested in a sports team or sporting game or other event. The client 102a is able to display sponsored branding. Branding includes banners, ads, video clips and other known Internet and traditional advertising methods.

Notification service 103a can be one or more computing systems, whether used separately, or in combination, for propagating information between a computing system such as a server, and a mobile device. The notification service 103a can provide encryption and communicate over an Internet protocol (IP) network. The notification service 103a can provide a channel for monitoring data intended for applications. The notification service 103a can receive a notification and, in response, transmit a message to a computing system. The notification message can range in complexity from a simple data file to a complex combination of various files, messages, and related information.

Feeds 104a can be a system for providing updated data from data sources to computing systems in real-time. Data can be transmitted as an event occurs to provide updates as to the status of the event. The updated data can be transmitted as structured or unstructured data.

Donation service 105a can be a system for soliciting voluntary contributions from individuals, businesses, governmental agencies and other entities interested in giving money. By way of example, donation service 105a can be implemented through Paypal, Google Checkout, or another convenient provider. Donation service could also be used to allow the user to purchase merchandise or tickets for upcoming games or other related merchandise.

Network 118b can be practically any type of communications network, such as, by way of example but not limitation, the Internet or an infrastructure network. The term “Internet” as used herein refers to a network of networks which uses certain protocols, such as the TCP/IP protocol, and possibly other protocols such as the hypertext transfer protocol (HTTP) for hypertext markup language (HTML) documents that make up the World Wide Web (the web).

In the example of FIG. 1A, server 101a assigns a unique client identifier to client 102a. Server 101a receives game and team statistics from Feeds 104a to create lines associated with each sports game or event. A challenge can be manually or automatically generated for a game as the lines are created and updated for that game. When a user wants to join a challenge, the user can use Client 102a to send a request to join the challenge, at which point Server 101a can provide the corresponding challenge’ most recent lines to Client 102a. The user can, for example, attempt to predict yes or no, or over or under, for these lines. In addition, Server 101a can provide tiebreaker lines that may or may not be a simple yes or no.

As used herein, a “sub-event” refers to an ever changing statistic for a team in a game. This can be, for example, “total passing yards” in “football.” The sub-event can change throughout the game, for example when a “pass” is “completed.” Such a “sub-event” can be used in calculating odds with respect to the perceived outcome of a game. The sub-event can be used in a challenge as a tie-breaker as well.

A “line” can refer to an instantaneous value calculated for the “sub-event.” Although the sub-event can change, the line can be the value at a specific moment in time. A user can choose “over or under” or otherwise predict a value for the “line.” Lines for the sub-events can be created for games where teams' statistics are available. In a game between Team A and Team B, for example, “total sacks” can be a sub-event used to generate lines. A “total sacks” “line” can be generated for each team. In one example, the line can be calculated for Team A by averaging Team A's total sacks allowed average with Team B's total sacks average. Averages can be calculated across the season, and vice versa for Team B.

As used herein a “pick” is a user prediction of either “over” or “under” with respect to a line. The selection can carefully planned, random or otherwise effected. If a user selects over as his pick with respect to a line, then the pick is successful where the game statistic associated with the line is over the line for that statistic. For example if the line for a football game is for the statistic “total points scored” and that value is set to 49 for the game and a user selects “over” as his pick, and the final score for the game is 21 to 35 then the pick will be successful because the total points scored came to 56. This can be calculated by adding the scores of both sides: 21÷35=56 and comparing the total score to the line value 49, to determine the pick is successful. The pick can be displayed with a related sub-event.

In the example of FIG. 1A, when the user submits picks through Client 102a to Server 101a, Server 101a can store these as the user's picks for the challenge. When a user's picks are saved, Client 102a can present, to the user, information related to the challenge which may include but is not limited to the sponsors' information, a video advertisement, and an option to donate and support the team or related organization. Should the user wish to make a donation, Client 102a can communicate with Donation Service 105a to perform the donation.

As used herein, a “challenge” is a competition between users with respect to a sub-event of at least one game. At least one, but also more than one sub-event can be the subject of the challenge. At least two, but also more than two users would be needed to join the challenge to make the challenge effective. Users can select one or more lines based on the sub-event and make their picks. Upon completion of the game, or point of conclusion of the challenge, the user(s) that was most successful can be said to have won the challenge. One, or more than one sponsor can sponsor a challenge. The sponsor may provide prizes to winners in the challenge. No money need be involved in the challenge itself.

In the example of FIG. 1A, Server 101a may provide live game updates to Client 102a to visualize against the user's picks for related challenges. As Server 101a receives game updates through a third party data feed. Server 101a can update the state of each line for each game. As the states for the lines are determined as a final, Server 101a can calculate scores for each user, such as by comparing the user's picks against the actual outcomes for the lines. When the challenge ends, Server 101a can determine the winner of the challenge as the user with the highest score.

FIG. 1B depicts a block diagram of an example of a client for playing a multiplayer interactive game in conjunction with an event. FIG. 1B includes a client 101b, application 102b, and a client identifier 103b.

The client 101b includes an application 102b and a client identifier 103b. The client 101b can be a client, as is discussed in reference to FIG. 1A.

App 102b can be a software application executing in the memory of a mobile device. For example, App 102b may be an application running on an Android operating system or an iOS operating system, as well as any other known or convenient operating system.

Client id 103b can be a client identifier useful to associate a user with a particular device. For example, Client Id 103b can be authenticated with an OpenID provider for the server system. Client 101b can include Client Id 103b in communications sent to a server system so that the server system can identify the source of the message. For example, the server system can map multiple user authentication into to a client identifier, allowing the user to use multiple accounts to login.

FIG. 1C depicts a block diagram of an example of a server for playing a multiplayer interactive game in conjunction with an event. FIG. 1C includes server 101c, sub-events engine 102c, game state engine 103c, server engine 104c, challenge decision engine 105c, teams database 106c, game database 107c, sub-events database 108c, user database 109c, challenge database 110c, and picks database 111c.

Server 101c can be a Server as discussed in reference to FIG. 1A.

Sub-events engine 102c can calculate a line associated with a game. Sub-events engine 102c can take as inputs statistics of the teams taking part in a game. As games that the teams are a part of complete the sub-events engine 102c can regularly recalculate a new line using regular updates.

As used in this paper, an “engine” includes hardware, firmware, or software implemented in hardware or firmware for execution by a processor. Engines can use dedicated independent hardware or can share hardware, as is convenient when implementing a system for a particular application.

Game state engine 103c can collect data from a data feed. Game state engine 103c can process data feeds to identify a game state and a team state and store the game state and team state in the game database 107c and teams database 106c, respectively.

As used herein, a “game state” includes at least one data point describing at least one sub-event. The game state can be collected as the game proceeds. For example, in football, as the game progresses sub-events relating to points scored, the number of sacks made, number of field goals kicked, and any other relevant statistics could each be included in a game state.

Server engine 104c can receive various requests from a client that include but are not limited to joining challenges, making picks, requesting challenge information, and viewing advertisement videos.

Challenge decision engine 105c can compare a game state and a pick in order to determine whether the pick accurately describes the game state. Challenge decision engine can execute at any time, such as during a challenge to determine the current status of users in the challenge. When operating at the end of the challenge, Challenge decision engine 105c can determine the winner of a challenge by analyzing the picks for the lines of the challenge to determine the winner of the challenge.

Teams database 106c can be a repository of team statistics relevant to calculating the lines for games, for example, if the game is football, yards, touchdowns, sacks, punts, total yards, passing yards could all be relevant statistics. Alternatively, for, e.g. baseball, batting averages, RBIs, pitching statistics, and other relevant data could be stored. The teams states are not limited to football and baseball; any game can provide the subject matter.

As used in this paper, a “repository” can be implemented, for example, as software embodied in a physical computer-readable medium on a general- or specific-purpose machine, in firmware, in hardware, in a combination thereof, or in any applicable known or convenient device or system. The repositories described in this paper are intended, if applicable, to include any organization of data, including tables, comma-separated values (CSV) files, traditional databases (e.g., SQL), or other known or convenient organizational formats.

In an example of a system where a repository is implemented as a database, a database management systems (DBMS) can be used to manage the repository. In such a case, the DBMS may be thought of as part of the repository or as part of a database server, or as a separate functional unit (not shown). A DBMS is typically implemented as an engine that controls organization, storage, management, and retrieval of data in a database. DBMSs frequently provide the ability to query, backup and replicate, enforce rules, provide security, do computation, perform change and access logging, and automate optimization. Examples of DBMSs include Oracle database, IBM DB2, FileMaker, Informix, Microsoft Access, Microsoft SQL Server, Microsoft Visual FoxPro, MySQL, and OpenOffice.org Base, to name several, however, any known or convenient DBMS can be used.

Database servers can store databases, as well as the DBMS and related engines. Any of the repositories described in this paper could presumably be implemented as database servers. It should be noted that there are two logical views of data in a database, the logical (external) view and the physical (internal) view. In this paper, the logical view is generally assumed to be data found in a report, while the physical view is the data stored in a physical storage medium and available to a specifically programmed processor. With most DBMS implementations, there is one physical view and an almost unlimited number of logical views for the same data.

Game database 107c can be a repository storing game states, which can include but are not limited to current teams scores and statistics. For example, if the game is football, sacks, touchdowns, and the current time in the game could be included as well as other convenient statistics. Alternatively, if the game is baseball, runs, runners on base, current inning, outs could be included as well as other convenient statistics. The game states are not limited to football and baseball; any game can provide the subject matter.

Sub-events database 108c can be a repository including lines calculated for each game. Such lines can be calculated according to values inputted by an individual familiar with the system, values taken from predictions by users, or any known or convenient source of estimating the odds for a game.

User database 109c can be a repository of users including a mapping of authentication information to client identifier.

Challenge database 110c can be a repository including challenge information, for example, data describing a game associated with a challenge, data describing lines associated with the challenge, and data describing users who have joined the challenge.

Picks database 111c can be a repository including data describing predictions made by users in reference to challenges associated with games.

A “pick” as used herein can be a user prediction of the outcome of a game with respect to a line. For example, a pick can be a win by 10 points, meaning that a first team will win a game against a second team by 10 points or more. A pick need not include a number of points, whether a team has won, or other factor; a pick can be in reference to any convenient aspect of a game.

Sub-events engine 102c can subscribe to third party data feeds to create and update lines for games and stores them in the sub-events database 108c.

In the example of FIG. 1C server engine 104c creates a challenge based on a game and game state engine 103c receives data via data feeds and stores the data in game database 107c. Server engine 104c manages requests from users to join the challenge. During the game, sub-events engine 102c retrieves the data from the game database and creates and updates lines. Server engine 104c receives user picks referencing various lines and stores the user picks in Picks database 111c. At various times, during or at the end of a game, challenge decision engine 105c evaluates users' picks against the lines to determine how users are doing in their challenges against each other. Ultimately the game ends and the challenge decision engine 105c decides a winner.

At any point in time, the various engines in the server 101c can publish notifications detailing various events that occur within the system. These notifications can be communicated to third party notification services or other components in the server 101c. For example, as the game state engine 103c updates the state of a specific football game, a notification can be published detailing the specific game update that occurred.

By way of example, the users can make picks and compete against one person or a group of people in predicting the most sub-events accurately on a college sporting event. However, one skilled in the art will appreciate that users may also make picks around other types of sporting events and sports including but not limited to basketball, baseball, football, soccer, golf, combat sports, cricket and any other sports whether affiliated with colleges, or not. The game could also be structured around any type of professional sporting event including races such as horse racing, dog racing, boat racing, cycling, motorcycle, car racing. The game could also be structured around non-sporting events such as Oscars, TV Shows or Movies. For any of these types of games, users could also view their standings for various challenges current and past through the client system.

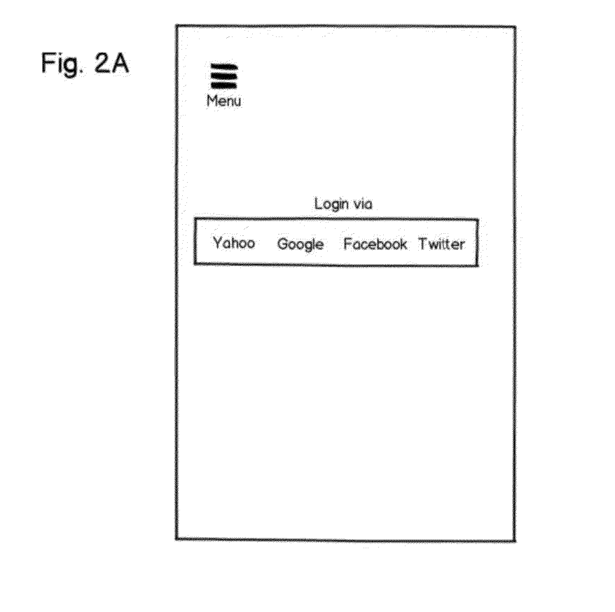

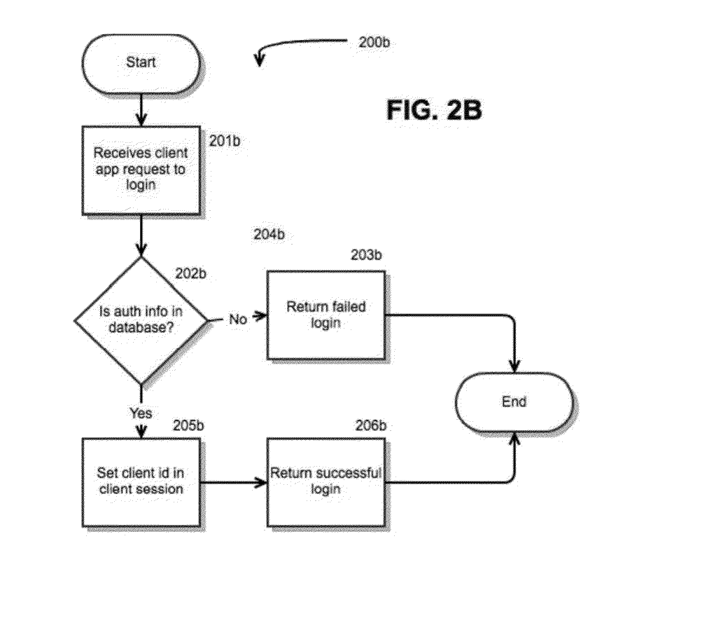

FIG. 2A visualizes an example of a login screen. The login can be accomplished using any system or provider for authenticating users. For example, an OpenID Provider, such as Facebook or Google, could be used to provide authentication services, such as is depicted. The example includes a screen showing what a client system could present when the user requests to login via, e,g. OpenID.

FIG. 2B depicts a flow diagram of an example of a routine that allows the user to login to the service with an OpenID account. The method is organized as a sequence of modules in the flowchart 200b. However, it should be understood that these and modules associated with the methods described herein may be reordered for parallel execution or into difference sequences of modules.

In the example of FIG. 2B, the flowchart 200b starts at module 201 where the server receives the client system request to login. The server can receive the request via a network including an identifier of the client and the request. For example, cookies could be used to store the client identifier and the cookie data could be transmitted via a network to the server.

In the example of FIG. 2B, the flowchart 200b continues at module 202 where the server system checks if the authentication information is in the database. Such can be accomplished by retrieving data describing the user from a database and comparing the data with a user id included in the authentication information.

In the example of FIG. 2B, if the check in module 202 returns no, then the flowchart 200b continues to step 203 and returns a “failed to login” response to the client system and the method completes. In this case, the flowchart terminates with the failure of the client to login.

In the example of FIG. 2B, if the check in module 202 returns yes, then the flowchart 200b continues to step 205 where it authenticates the client connection. The server authenticates the connection for future requests by setting the client identifier, which was retrieved from the database, in the connection with the client system.

In the example of FIG. 2B, the flowchart 200b continues to module 206 where the server returns a “login successful” response to the client. Having returned the response to the client, the flowchart ends.

The user may choose to login to the server system with an OpenID Provider or OpenID-like system. When the user chooses to do so, the user is redirected to the OpenID provider application to authenticate. After authenticating with the provider, the user is redirected back to application and the client system sends a request to login to the server system.

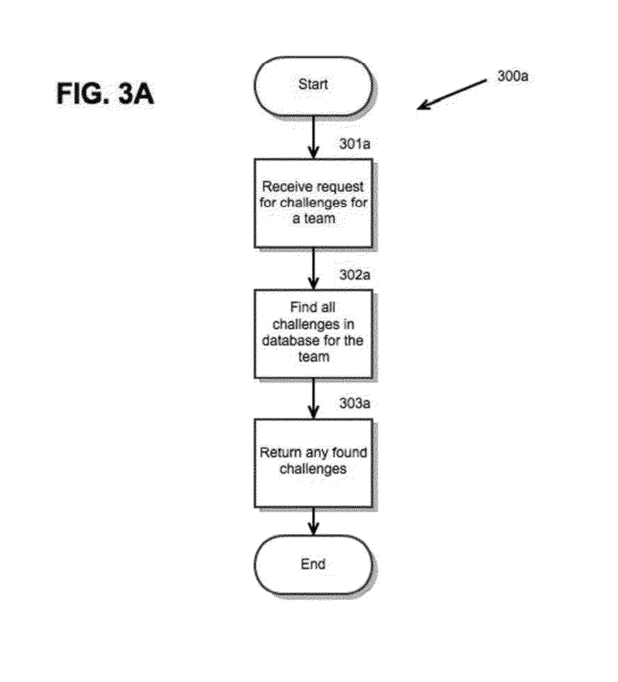

FIG. 3A is a flow diagram of an example of a routine to retrieve challenges for a team. The method is organized as a sequence of modules in the flowchart 300a. However, it should be understood that these and modules associated with the methods described herein may be reordered for parallel execution or into difference sequences of modules.

In the example of FIG. 3A, the flowchart 300a starts at module 301a with receiving a request for challenges for a sports team. The request could be generated by a user seeking a challenge to join, such as by selecting the team to find all associated challenges or selecting the challenge that the user has been invited to.

In the example of FIG. 3A, the flowchart 300a continues to module 302a with searching through the challenges database to find challenges that are associated with the sports team. Where a game matches the sports team, the challenge can match the team.

In the example of FIG. 3A, the flowchart 300a continues to module 303a with the server system returning the found challenges to the client system. Such can be returned as a message or series of messages including the data describing the various challenges associated with the team. Returning the challenges to the client, the flowchart ends.

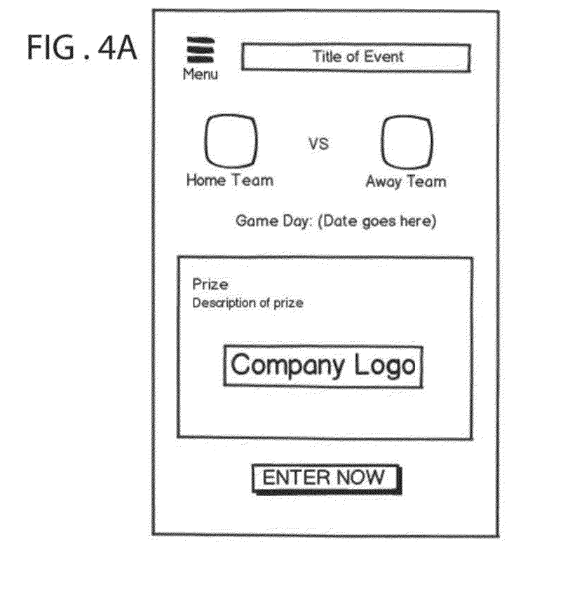

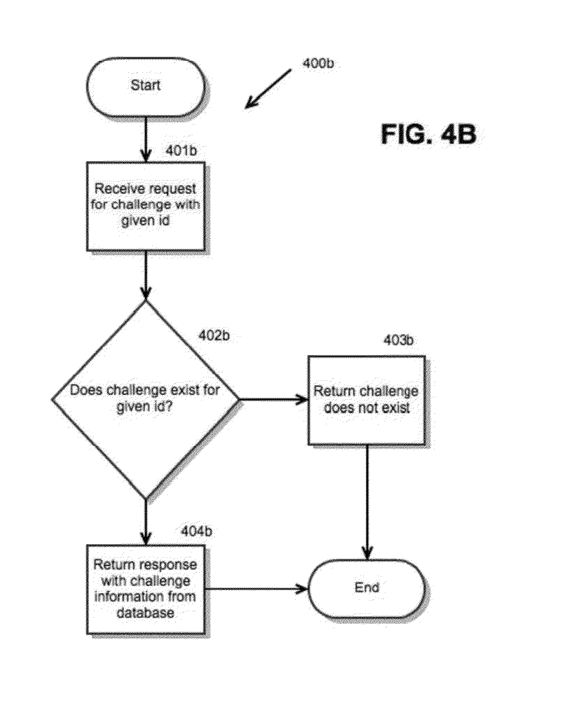

FIG. 4A illustrates a view of an example for a challenge's details. This view gives the user the opportunity to view information about the game for the challenge, the sponsor of the challenge, and prize information. It also gives the user the ability to join the challenge. When the user views this screen, the client system sends a request for challenge details to the server system.

FIG. 4B is a flow diagram of a routine to retrieve challenge details. The method is organized as a sequence of modules in the flowchart 400b. However, it should be understood that these and modules associated with the methods described herein may be reordered for parallel execution or into difference sequences of modules.

In the example of FIG. 4B, the flowchart 400b starts at module 401b with the server system receiving a request for the challenge details for a challenge with the given id. Such data can be communicated over a network at the request of a user of a client device.

In the example of FIG. 4B, the flowchart 400b continues to module 402b with the server system checking if the challenge exists in the database. Such can be accomplished by retrieving data from a database and comparing the data with an identifier for the challenge. The decision can be a yes where one or more challenges match the identifier. The decision can be no where no challenges match the identifier.

In the example of FIG. 4B, if module 402b returns no, the flowchart 400b continues to step 403b and returns the challenge does not exist. Having returned that the challenge does not exist, flow chart ends.

In the example of FIG. 4B, if module 403b returns yes, the flowchart 400b continues to step 404b and returns the challenge information to the client system. Returning the challenge information to the client, the flowchart ends.

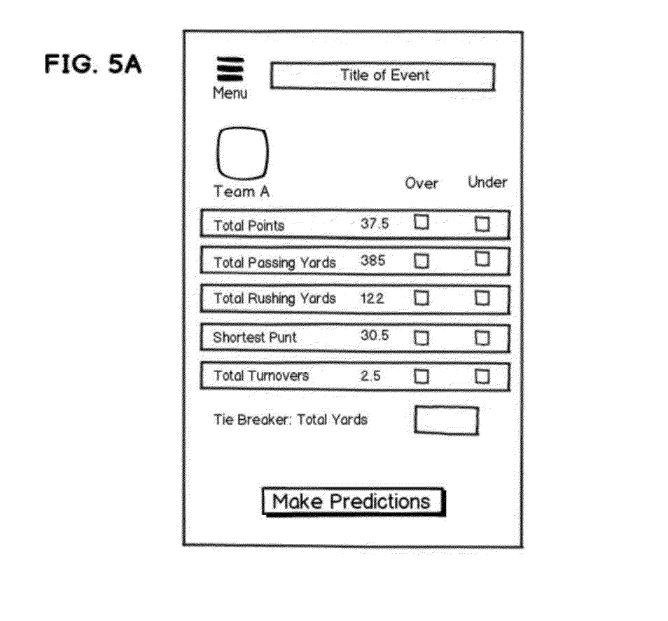

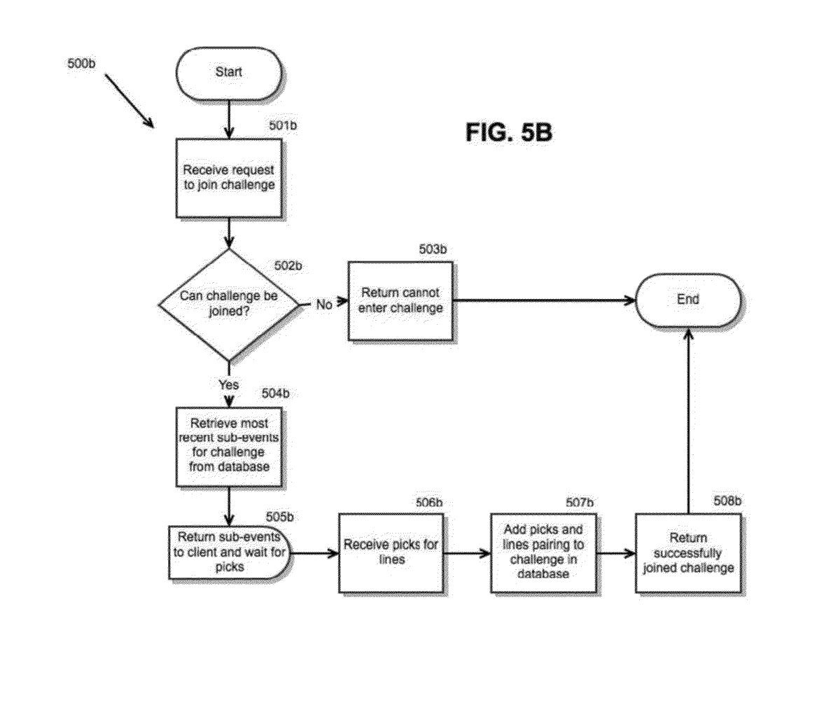

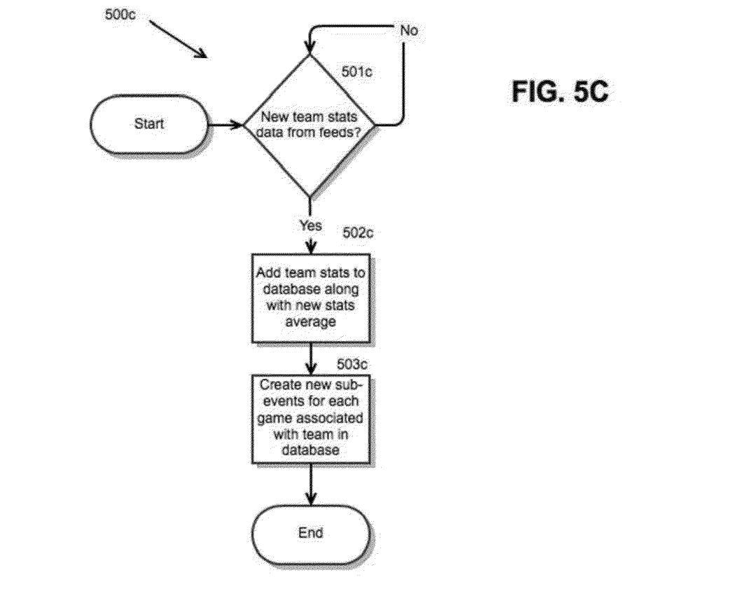

FIG. 5A illustrates an example of a making predictions for the sub-events for a challenge. The client system presents FIG. 5A to the user to make picks for the lines returned from the server system. In the example view, the user must choose over/under for total points, total passing yards, total rushing yards, shortest punt, and total turnovers. The tie-breaker total yards must also be entered. This screen will be shown once for each team in the challenge. When the user chooses to make the predictions, the client system sends the picks to the server system.

FIG. 5B is a flow diagram of an example of a routine to make picks for the sub-events for a challenge. The method is organized as a sequence of modules in the flowchart 500b. However, it should be understood that these and modules associated with the methods described herein may be reordered for parallel execution or into difference sequences of modules.

In the example of FIG. 5B, the flowchart 500b starts at module 501b with the server system receiving a request for a client to join the challenge.

In the example of FIG. 5B, the flowchart 500b continues to module 502b with the server system checking if the challenge can be joined. A challenge may be joined if one or more lines exist for a challenge. However, if the game associated with the challenge has not yet started, this information can also be returned. Similarly, should the client have already joined a challenge, that information can be returned as well.

In the example of FIG. 5B, if module 502b returns no, the flowchart 500b continues to step 503b and returns a response that the challenge cannot be entered. Returning the response to the client, the flowchart ends.

In the example of FIG. 5B, if the module 502b returns yes, the flowchart 500b continues to step 504b with the server system retrieving the most recent sub-event's lines from database for the game in the challenge. Such data can be retrieved from a database storing the information.

In the example of FIG. 5B, the flowchart 500b continues to module 505b with the server system returning the lines to the client system and waiting for the picks from the user.

In the example of FIG. 5B, the flowchart 500b continues to module 506b with the server system receiving picks for the lines. These picks can be received over a network from a user seeking to enter a challenge.

In the example of FIG. 5B, the flowchart 500b continues to module 507b with the server system adding the users' picks for the lines to the respective databases.

In the example of FIG. 5B, the flowchart 500b continues to module 508b with the server returning a response to the client stating that the user has joined the challenge successfully. For all predictions that are accepted by the server system, the system assigns a unique reference number to predictions. This reference number can be used to provide an audit trail. Returning the response to the client, the flowchart ends.

FIG. 5C is a flow diagram of an example of a routine useful to create sub-events. The method is organized as a sequence of modules in the flowchart 500c. However, it should be understood that these and modules associated with the methods described herein may be reordered for parallel execution or into difference sequences of modules.

In the example of FIG. 5C, the flowchart 500c starts at module 501c with the server system continuously receiving data from a third party feed until it receives new stats for a team. For example, these statistics could include, but are not limited to, total passing yards and total rushing yards for past football games.

In the example of FIG. 5C, the flowchart 500c continues to module 502c with the server system adding the teams' statistics to the database along with new averages. For example, if a statistic is “total sacks allowed,” then data describing the total sacks allowed averaged across all the games in the current season can be stored in the database.

In the example of FIG. 5C, the flowchart 500c continues to module 503c with the server creating lines for each of the sub-events for the games that the team is associated with and completes. Returning from creating and storing the storing the lines in the database, the flowchart ends.

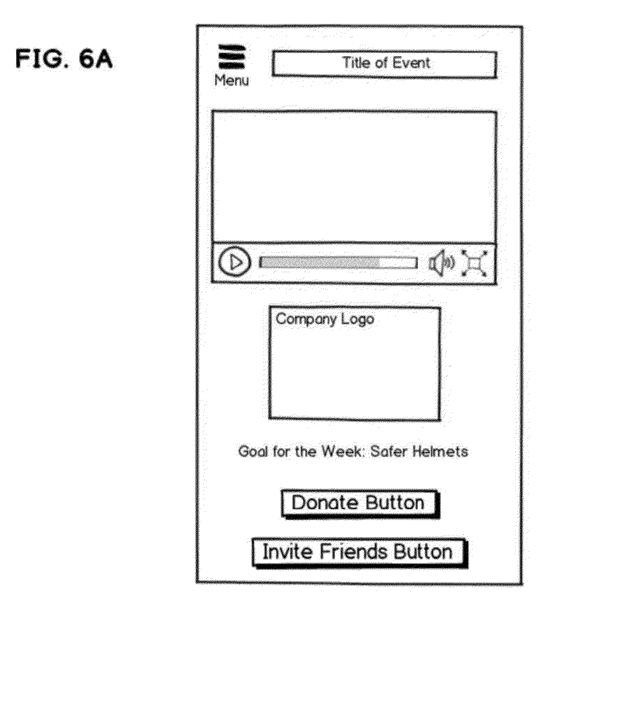

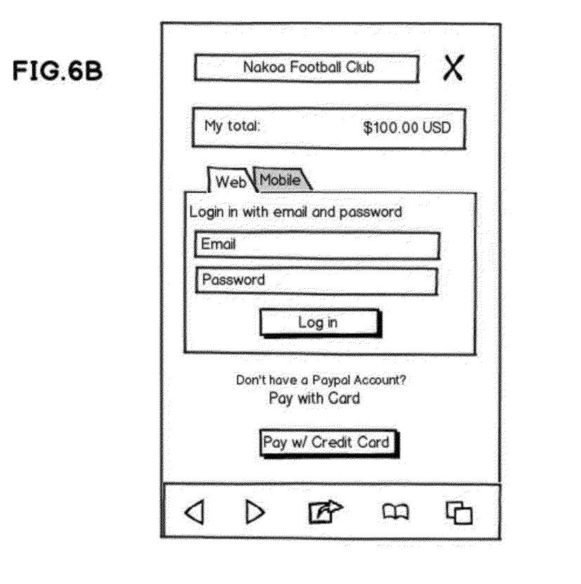

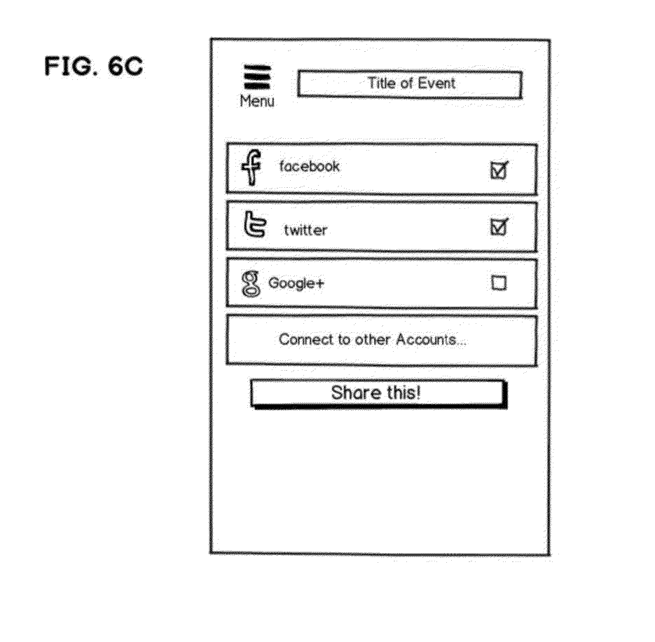

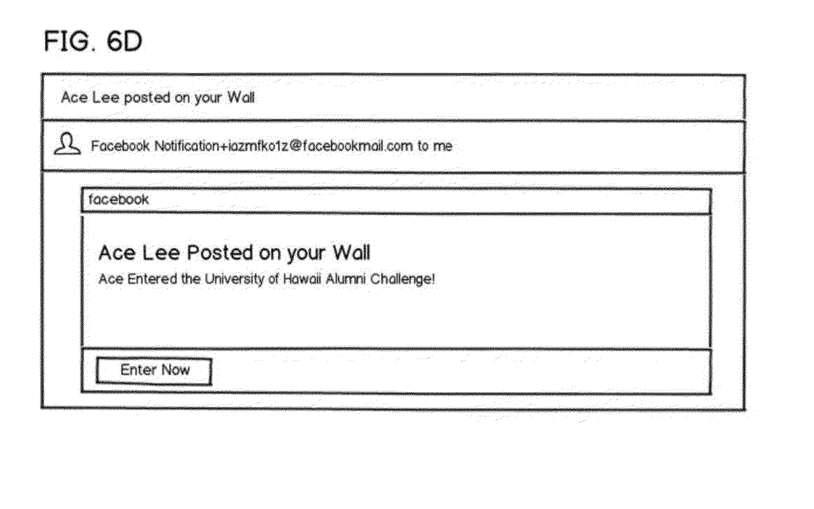

FIG. 6A illustrates a view of an example of a user interface useful to give a user the option to share, donate, view sponsor advertisement, and details of the challenge. After the user submits picks for a challenge, the client system makes a request to the server system to retrieve the challenge sponsor details, video advertisement, and other related challenge details. After the server responds with that information, the client system displays a view as shown in FIG. 6A to engage the user with the sponsor through a video, allow the user to easily share a challenge and invite friends via social graphs like Facebook and Twitter. The social graph information can be used through the authentication information provided by the login process. Some OpenID Providers, or OpenID-like systems, also provide API's to contact the social graph through email, importing of contacts and other well known methods to contact users digitally.

FIG. 6B illustrates an example of a donation screen.

FIG. 6C illustrates an example of a share screen. This screen allows the user to share the challenge through these various social graphs.

FIG. 6D illustrates a user's friend receiving a notification that the user has joined a challenge. Users are able to tailor social networking sites, for example, Facebook, and other ways to share and post their activity to fit their own requirements. For example, one customer may want to have all their activity post on a social networking site such as a Facebook wall or a Twitter wall. However, another customer ma want all activity completely private. Either option is available to the user. Further, users can represent various organizations and entities and can make donations to various types of organizations other than just college sports booster organizations. Some examples of organizations include schools, churches, non-profits, clubs, the Lion's Club and various other organizations.

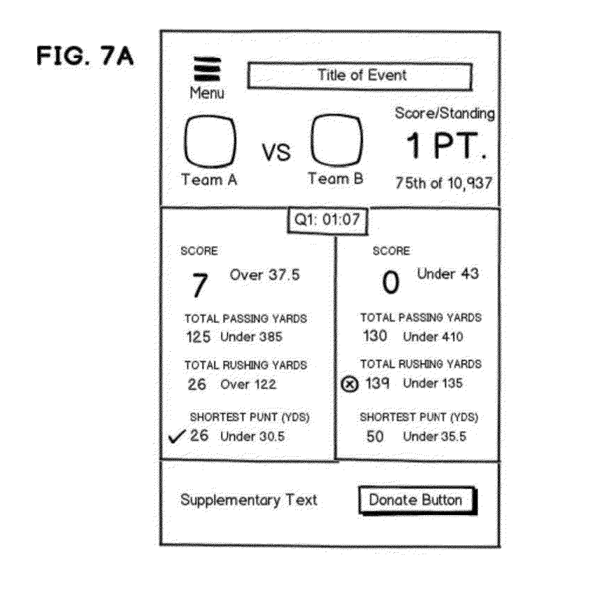

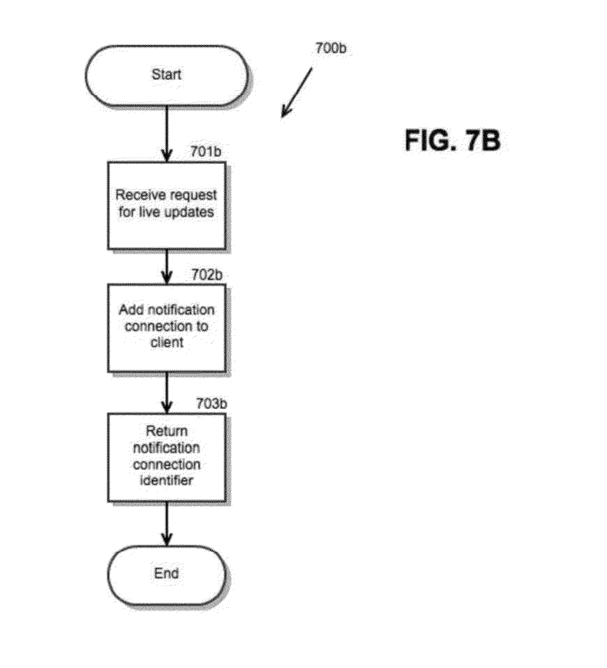

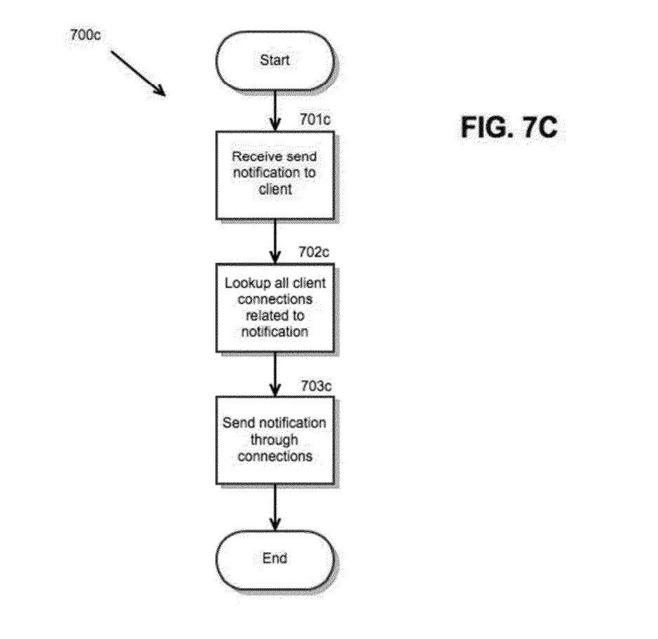

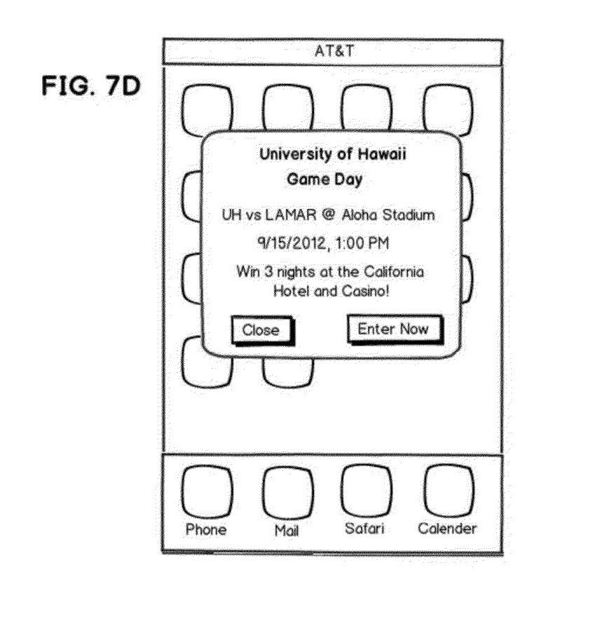

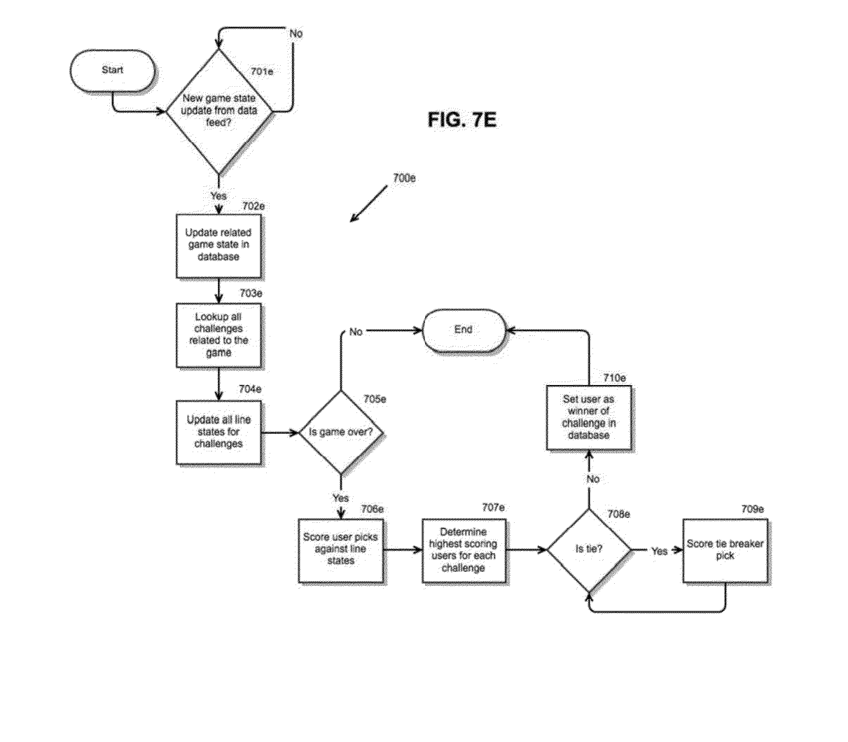

FIG. 7A illustrates an example of viewing a user's line's picks against the current live game state. The live game state can be received by notifications or by simply requesting the current state of an ongoing game. The client displays FIG. 7A allowing the user to view a user's picks against a live updating feed of the game state associated with a challenge. Data shown is the user's picks for each of the sub-events for both teams such as Total Passing Yards, Total Rushing Yards, and Shortest Punt (yds). The view can display the current standing of the user's picks against all other members in the challenge along with how many points the user has in that challenge. The number of points reflects how the system scores a win or a lose for a given line. The view displays the user's current picks state whether win or lost. The user is also given an option to donate.

FIG. 7B is a flow diagram of an example of a routine useful to enable game updates to a client application. The method is organized as a sequence of modules in the flowchart 700b. However, it should be understood that these and modules associated with the methods described herein may be reordered for parallel execution or into difference sequences of modules.

In the example of FIG. 7B, the flowchart 700b starts at module 701b with the server system receiving a request from the client system for live updates related to a challenge.

In the example of FIG. 7B, the flowchart 700b continues to module 702b with the server system creating a live update connection to the client, for example using XMPP, Apple Push Notification Service (APNS), Google Cloud Messaging (GCMM), or other known notification services.

In the example of FIG. 7B, the flowchart continues to module 703b and returns the identifier to the client. A server system can store the connection identifier in the database for the user. The user may be able to configure what types of notifications and how often they are received. Notifications include but are not limited to game updates, challenge pick updates, and challenge state updates such as the user winning or losing the challenge. Returning from storing the identifier in the database, the flowchart ends.

FIG. 7C is a flow diagram of an example of a routine to push game updates to a client application. The method is organized as a sequence of modules in the flowchart 700c. However, it should be understood that these and modules associated with the methods described herein may be reordered for parallel execution or into difference sequences of modules.

In the example of FIG. 7C, the flowchart 700c starts at module 701c with the server system receiving a request to send a notification to a user. In various places in the server system, a notification for a game or challenge can be initiated. For example, as a game is progressing for a challenge, the state of the game in the database will be updated to reflect the real time state of the game. This state update triggers live update notification to a user if the user has joined the challenge and enabled live updates for the challenge.

A notification can be sent to notify that a challenge is open for users to make picks. This type of notification can be sent on a set schedule, for example, a set number of days before the start of a challenge where the start of the challenge is the earliest start date amongst the games related to a challenge. This type of notification can also be sent when the first lines for the sub-events for a challenge have been created.

In the example of FIG. 7C, the flowchart 700c continues at module 702c with the server system looking up all client connections related to the request. For example, if a request to send notifications for a game state update is received, the server system will look through all challenges that relate to the game and find all users who have joined that challenge. The server system will then look up all the client connections for those users who have enabled live updates.

In the example of FIG. 7C, the flowchart continues to module 703c with the server sending a notification through each client connection from module 704c. If push notifications are not enabled for a user, the user will not receive a live update notification. Returning from sending the notification to all relevant connections, the flowchart ends.

FIG. 7D visualizes an example of receiving a challenge update notification. A client system can respond to notifications from the server system by updating the user interface and presenting a view specific to the notification. In this example, the client system receives a notification that a challenge has opened up for users to make picks. The client system decides to visualize this notification by showing a pop up detailing when the challenge starts, where the game that relates to the challenge will take place and who the players are, and giving the option to the user to dismiss the pop up or enter the challenge.

FIG. 7E is a flow diagram of an example of a routine to update game and challenge states. The method is organized as a sequence of modules in the flowchart 700e. However, it should be understood that these and modules associated with the methods described herein may be reordered for parallel execution or into difference sequences of modules.

In the example of FIG. 7E, the flowchart 700e starts at module 701e with the server continuously receiving data from third party data feeds waiting for a new update for a game. Live updates can be pushed and received through a socket or other known protocol to allow remote connections. A new update for a game can include but is not limited to the live statistics of a game. For example, during a live football game, game stats will be available that will contain but is not limited to the score for each team in the game, the current total yards for each team, and the number of punts for each team. This data will be available in the feed after a play is made in the game or another event occurs that affects statistics related to a game or the state of a game which includes but is not limited to time left or field possession.

In the example of FIG. 7E, the flowchart 700e continues to module 702e with the server system updating the game state in the database related to the update received.

In the example of FIG. 7E, the flowchart 700e continues to module 703e with the server system looking up all challenges that relate to the game state that was updated to find which lines must be updated. Since the game has been updated, the state of all the lines for the challenges can be updated as well.

In the example of FIG. 7E, the flowchart 700e continues to module 704e with the server updating each line state based on current game state information. For example, if the line is Total Passing Yards 300 and the game state update relates to a completed pass for a team in the game, that line is updated to include the current total passing yards.

In the example of FIG. 7E, the flowchart 700e continues to module 705e with the server checking if the game is over.

In the example of FIG. 7E, if module 705e returns no, the flowchart 700e ends having determined that the game is not over.

In the example of FIG. 7E, if module 705e returns yes, the flowchart 700e server system continues to step 706e with scoring user picks. The user picks are compared against each related line and a point is awarded for a pick that matches the line state. For example, if the line is Shortest Punt 30.5 yards, the shortest punt was 30 yards, and the user chose under, the user is awarded one or more points. One skilled in the art will recognize that the particular number of points may be implementation specific and that various systems may use different numbers of points.

In the example of FIG. 7E, the flowchart 700e continues to module 707e with the server totaling user's points to determine the highest scoring user in the challenge.

In the example of FIG. 7E, the flowchart 700e continues to module 708e to determine if there is a tie in the challenge.

In the example of FIG. 7E, if module 708e returns yes, then the flowchart 700e continues to module 709e with the server systems scoring tiebreaker picks for the users that tied in step 709e. A tiebreaker pick can be any pick as determined with reference to the particular game itself. For example, if the user has 3 different picks, one could be selected at random, one could be selected at the outset of the challenge as a tiebreaker, or any other convenient method for selecting a tiebreaker could be used.

A tiebreaker can be made from select game or team statistics related to the game. Statistics include hut are not limited to Game Total Rushing Yards and Game Total Passing Yards. For example, a tiebreaker line can be made for Game Total Rushing Yards. A user will predict the Game Total Rushing Yards and use that as the pick for the line. The Game Total Rushing Yards can be computed by totaling the rushing yards for both teams for the game. When the pick is scored, more points will be given for predictions that come closer to the actual statistic of the game.

In the example of FIG. 7E, the flowchart continues to module 707e to repeat the process of determining the highest scoring user.

In the example of FIG. 7E, if module 708e returns no, then the flowchart 700e continues to module 710e with the server setting the highest scoring user as the winner of the challenge. The server system sets that user as the winner of the challenge in the database. Returning from setting the winner in the database, the flowchart ends.

There may also be more than one winner for a challenge. Multiple winners can result from users ending up with the same score or by selecting the top x scoring users, where x is a number set before the challenge ends.

Picks may also be scored throughout the game. The type of sub-event determines and the current game state determines whether or not the associated pick can be scored. For example, a pick for Total Passing Yards sub-event may be scored once a team's total passing yards passes the value of the line for the sub-event. Picks may also be scored differently by being weighted or being worth different amount of points depending on the type of line. Throughout the process of updating the state of the game and challenges, the server system may send out notifications in the system of the updates that have occurred. For example, when a game state is updated, a notification will be sent out stating that game was updated in the database.

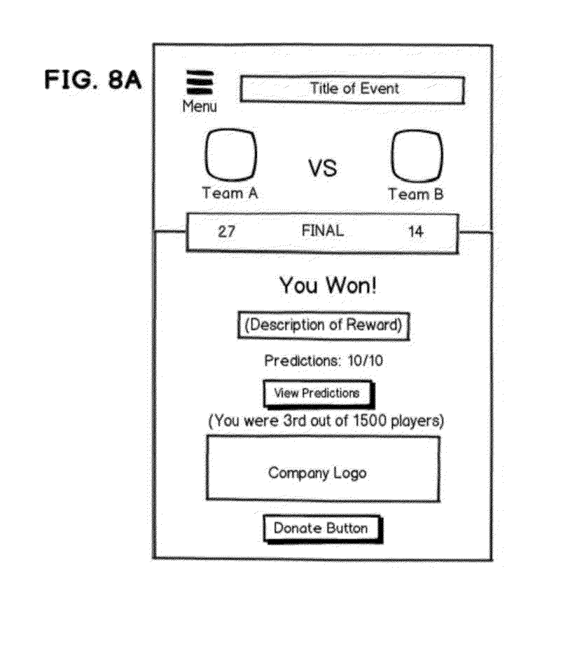

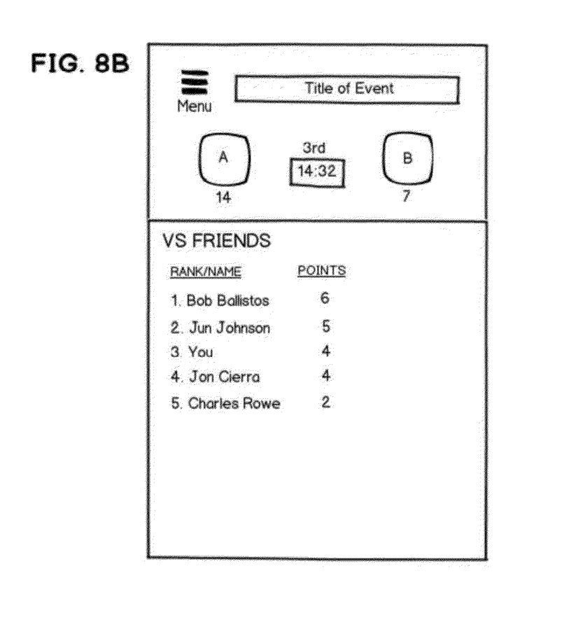

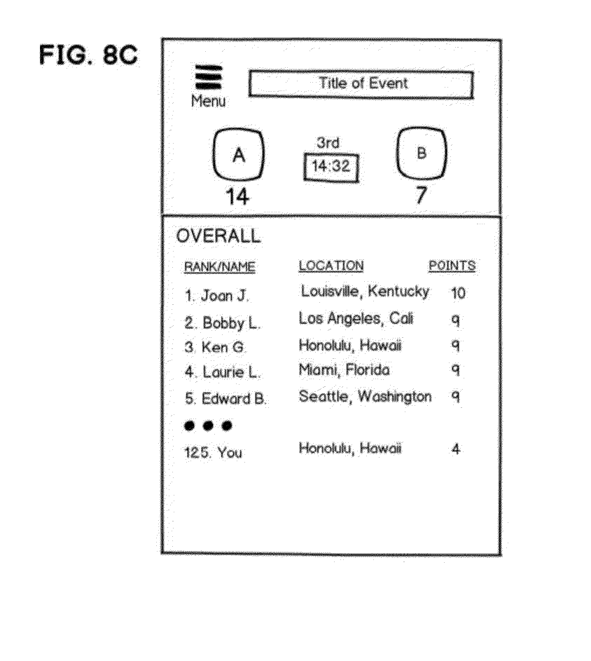

FIG. 8A visualizes an example of the final result view for a challenge as it pertains to a user's overall final place in the challenge. When a challenge completes, the client system makes a request to the server system for the challenge result information and displays it to the user. The user is shown the final score, whether or not the user has won, a description of the reward won, an option to view the user's picks for the challenge, the sponsor's company logo, and an option to donate.

FIG. 8B visualizes an example of a user's place amongst friends in a challenge. The points shown can be calculated based on scoring the picks against the game state for the challenge.

FIG. 8C visualizes an example of a user's place amongst all users in a challenge. The points shown can be calculated based on scoring the picks against the game state for the challenge.

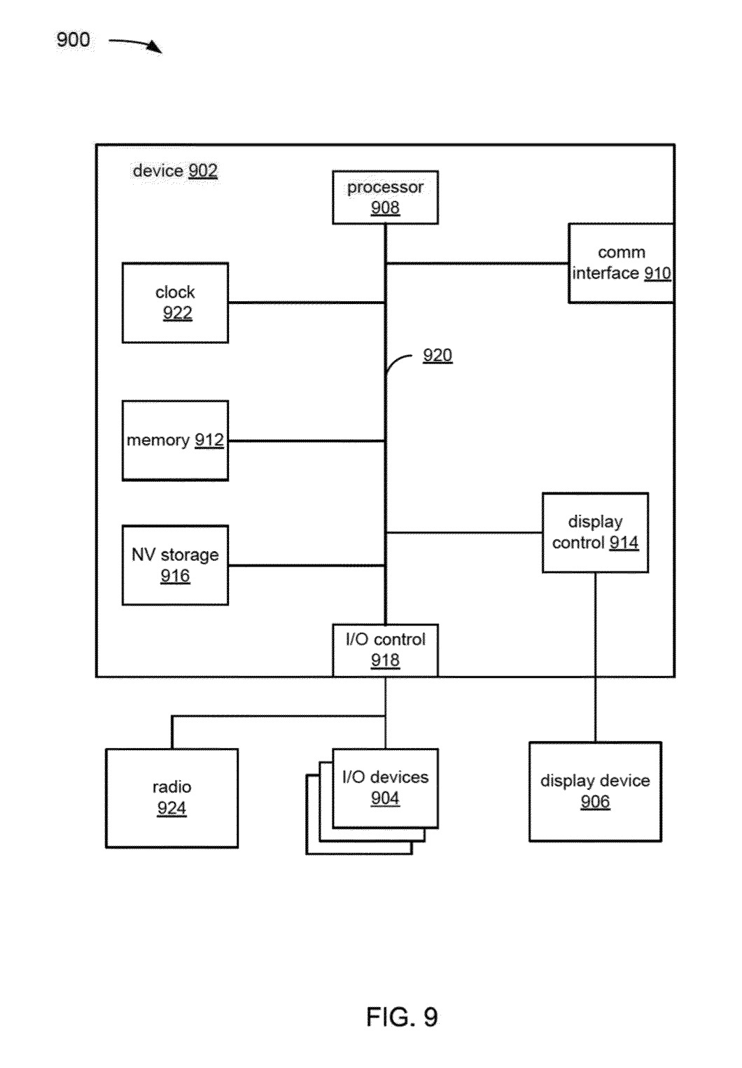

FIG. 9 depicts an example of a system for playing a multi-player interactive game in conjunction with an event. The system 900 may be a conventional computer system that can be used as a client computer system, such as a wireless client or a workstation, or a server computer system. The system 900 includes a device 902, I/O devices 904, and a display device 906. The device 902 includes a processor 908, a communications interface 910, memory 912, display controller 914, non-volatile storage 916, I/O controller 918, clock 922, and radio 924. The device 902 may be coupled to or include the I/O devices 904 and the display device 906.

The device 902 interfaces to external systems through the communications interface 910, which may include a modem or network interface. It will be appreciated that the communications interface 910 can be considered to be part of the system 900 or a part of the device 902. The communications interface 910 can be an analog modem, ISDN modem or terminal adapter, cable modem, token ring IEEE 802.5 interface, Ethernet/IEEE 802.3 interface, wireless 802.11 interface, satellite transmission interface (e.g. “direct PC”), WiMAX/IEEE 802.16 interface, Bluetooth interface, cellular/mobile phone interface, third generation (3G) mobile phone interface, code division multiple access (CDMA) interface, Evolution-Data Optimized (EVDO) interface, general packet radio service (GPRS) interface, Enhanced GPRS (EDGE/EGPRS), High-Speed Downlink Packet Access (HSPDA) interface, or other interfaces for coupling a computer system to other computer systems.

The processor 908 may be, for example, a conventional microprocessor such as an Intel Pentium microprocessor or Motorola power PC microprocessor. The memory 912 is coupled to the processor 908 by a bus 920. The memory 912 can be Dynamic Random Access Memory (DRAM) and can also include Static RAM (SRAM). The bus 920 couples the processor 908 to the memory 912, also to the non-volatile storage 916, to the display controller 914, and to the I/O controller 918.

The I/O devices 904 can include a keyboard, disk drives, printers, a scanner, and other input and output devices, including a mouse or other pointing device. The display controller 914 may control in the conventional manner a display on the display device 906, which can be, for example, a cathode ray tube (CRT) or liquid crystal display (LCD). The display controller 914 and the I/O controller 918 can be implemented with conventional well known technology.

The non-volatile storage 916 is often a magnetic hard disk, flash memory, an optical disk, or another form of storage for large amounts of data. Some of this data is often written, by a direct memory access process, into memory 912 during execution of software in the device 902. One of skill in the art will immediately recognize that the terms “machine-readable medium” or “computer-readable medium” includes any type of storage device that is accessible by the processor 908.

Clock 922 can be any kind of oscillating circuit creating an electrical signal with a precise frequency. In a non-limiting example, clock 922 could be a crystal oscillator using the mechanical resonance of vibrating crystal to generate the electrical signal.

The radio 924 can include any combination of electronic components, for example, transistors, resistors and capacitors. The radio is operable to transmit and/or receive signals.

The system 900 is one example of many possible computer systems which have different architectures. For example, personal computers based on an Intel microprocessor often have multiple buses, one of which can be an I/O bus for the peripherals and one that directly connects the processor 908 and the memory 912 (often referred to as a memory bus). The buses are connected together through bridge components that perform any necessary translation due to differing bus protocols.

Network computers are another type of computer system that can be used in conjunction with the teachings provided herein. Network computers do not usually include a hard disk or other mass storage, and the executable programs are loaded from a network connection into the memory 912 for execution by the processor 908. A Web TV system, which is known in the art, is also considered to be a computer system, but it may lack some of the features shown in FIG. 9, such as certain input or output devices. A typical computer system will usually include at least a processor, memory, and a bus coupling the memory to the processor.

In addition, the system 900 is controlled by operating system software which includes a file management system, such as a disk operating system, which is part of the operating system software. One example of operating system software with its associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage 916 and causes the processor 908 to execute the various acts required by the operating system to input and output data and to store data in memory, including storing files on the non-volatile storage 916.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is Appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present example also relates to apparatus for performing the operations herein. This Apparatus may be specially constructed for the required purposes, or it may comprise a general purpose computer selectively activated or reconfigured by a computer program stored in the computer. Such a computer program may be stored in a computer readable storage medium, such as, but is not limited to, read-only memories (ROMs), random access memories (RAMs), EPROMs, EEPROMs, flash memory, magnetic or optical cards, any type of disk including floppy disks, optical disks, CD-ROMs, and magnetic-optical disks, or any type of media suitable for storing electronic instructions, and each coupled to a computer system bus.

The algorithms and displays presented herein are not inherently related to any particular computer or other Apparatus. Various general purpose systems may be used with programs in accordance with the teachings herein, or it may prove convenient to construct more specialized Apparatus to perform the required method steps. The required structure for a variety of these systems will appear from the description below. In addition, the present example is not described with reference to any particular programming language, and various examples may thus be implemented using a variety of programming languages.

What is claimed is:

1. A system for hosting challenges in conjunction with live sports games comprising:
a server engine receiving a pick for a game used on a line, the game being subject to a challenge over a sub-event wherein the pick describes the sub-event in a future time in reference to the line; wherein accuracy of the pick is used to determine a winner of the challenge at the future time:
a game state engine receiving a game state at a current time and storing the information in a game state database for use in calculating the line in reference to the sub-event; wherein the pick is comparable to the line;
a teams database including two or more teams that are competing in the game;
a sub-events engine retrieving information from the teams database and the game state database to use in continuously calculating the line and storing the line in the sub-events database; and
a challenge decision engine comparing the line with the pick at the future time in order to determine whether the pick accurately described the game state at the future time.

2. The system of claim 1, further comprising a game database including additional games that are available for challenges.

3. The system of claim 1, further comprising a user database including data describing a user; wherein the data is used to associate the pick with the winner of the challenge.

4. The system of claim 1, further comprising a challenge database storing data describing the challenge in relation to the game.

5. The system of claim 1, further comprising a picks database including the pick.

6. A method for determining winners of a challenge in conjunction with live sports game comprising:
receiving, over a network connection, a game state associated with a game; wherein the game state describes a sub-event at a current time; wherein a line can be calculated in reference to the sub-event using the game state;
retrieving, from memory for processing, a challenge associated with the game; wherein two or more competing picks for a line associated with the sub-event have been received; wherein the outcome of the challenge can be determined by scoring the picks in comparison with the sub-event at a future time;
processing an update to a sub-event in memory through executing instructions on a processor; wherein the update defines the sub-event at a current time using the game state;
scoring a pick against the event state in memory through executing instructions on a microprocessor to produce a score for the pick;
comparing, in memory, the score against another score for the challenge; wherein the result of the comparison determines a challenge-winner regardless of a game-winner.

7. The method of claim 6, further comprising identifying all challenges in the database associated with a team.

8. The method of claim 6, further comprising determining that challenge does not exist for a specific team and creating the challenge.

9. The method of claim 6, further comprising adding team statistics to the database, wherein the statistics describe the team in reference to the game.

10. The method of claim 6, further comprising displaying the pick with the sub-event.

11. The method of claim 6, further comprising establishing a tie-breaker for a challenge where the result of the comparison is a tie for the challenge-winner.

12. The method of claim 6, further comprising pushing a notification to a user.

13. A method, stored in memory as instructions for a microprocessor, for hosting challenges in conjunction with live sports games comprising:
receiving a pick for a game based on a line, the game being subject to a challenge over a sub-event; wherein the pick describes the sub-event at a future time; wherein accuracy of the pick is used to determine a winner of the challenge at the future time;
receiving a game state at a current time and storing the game state in a game state database for use in calculating the line in reference to the sub-event;
comparing the sub-event and the pick at the future time to determine the winner of the challenge in reference to the sub-event.

14. The method of claim 13, further comprising identifying two or more teams competing in the game.

15. The method of claim 13, further comprising receiving data describing a user that provided the pick.

16. The method of claim 13, further comprising displaying the pick with the sub-event.

17. The method of claim 13, further comprising establishing a tie-breaker for a challenge where the result of the comparison is a tie for the challenge-winner.

18. The method of claim 13, further comprising pushing a notification to a user.
